(19) United States
(12) Patent Application Publication
(10) Pub. No.: US 2006/0015846 A1
(43) Pub. Date: Jan. 19, 2006

(54) Portal friendly user interface widgets

(75) Inventors: John H. Fraleigh, Cary, NC (US); Robert C. Leah, Cary, NC (US); Paul F. McMahan, Apex, NC (US); Kenneth J. Parzygnat, Apex, NC (US)

Correspondence Address: HOFFMAN, WARNICK & D'ALESSANDRO LLC, 75 STATE ST, 14 FL, ALBANY, NY, 12207, US

(73) Assignee: International Business Machines Corporation, Armonk, NY (US)

(21) Appl. No.: 10/891,242

(22) Filed: Jul. 14, 2004

(51) Int. Cl. G06F 9/44; G06F 17/24

(52) U.S. Cl. 717/109; 715/517

(57) ABSTRACT

The present invention provides portal friendly user interface widgets that can detect environmental factors in a portal page and automatically adjust the markup they produce based on the detected environmental factors. Each portal friendly widget comprises: a system for detecting at least one environmental factor in a portal page; and a system for automatically adjusting markup produced by the portal friendly widget based on the at least one detected environmental factor.

### BACKGROUND OF THE INVENTION

1. Field of the Invention

The present invention generally relates to web portal technology. More particularly, the present invention provides portal friendly user interface widgets that can detect environmental factors in a portal page and automatically adjust the markup they produce based on the detected environmental factors.

2. Related Art

Web portals are very user friendly because they allow the end user to pick which views (i.e., portlets) are combined on a portal page as well as how those portlets are arranged. After picking the portlets for a portal page and arranging the portlets, the user then has control over the state of each portlet in the portal page. Examples of states that a portlet can be placed in are Minimized, Maximized, Normal, Help, and Configure. In the Minimized state, the portlet renders minimal output or no output at all in the portal page. In the Maximized state, the portlet is the only portlet rendered in the portal page, or the portlet is rendered using more space compared to other portlets in the portal page. A portlet can typically generate richer content when its window state is in the Maximized state. In the Normal state, the portlet is arranged with other portlets in the portal page. In the Help state, the portlet provides a help page for users to obtain more information about the portlet. In the Configure state, the portlet provides a page for portal administrators to configure the portlet for a user or group of users. Other states, if supported, can also used (e.g., a Print state that provides a printer friendly version of the contents of the portlet).

Portal developers face a significant challenge in creating portlet code because the code must be capable of generating content markup that takes all of these portal capabilities into account. For example, if a user has put together a crowded portal page with a two column layout, then that portal page typically will look very busy since each portlet has limited screen real estate. An example of such a “busy” portal page 10 is illustrated in FIG. 1. As shown, the portal page 10 includes Portlet 1 that occupies the left column of the portlet page 10, and Portlets 2 and 3 that occupy and share the right column of the portlet page 10. On the other hand, if the user has placed a portlet on a portal page by itself, or has put the portlet in its Maximized state, then the portal page will not look as busy since the portlet has a generous portion of screen real estate available for rendering. Such a portal page 12 that includes a single portlet (e.g., Portlet 1) is illustrated in FIG. 2.

Currently, much of the portlet code created by portal developers does not take the full range of possible portal page states into account. These portal developers often design their code for the single most likely type of view their portlets will have in a portal page and disregard the other potential views. Taking these shortcuts diminishes the usability of the portlets, but is often necessary because adjusting the portlet markup requires the developer to write a lot of extra code that detects the portal page state and then interacts heavily with the underlying widgets that make up the portlets, adjusting their properties and data. As such, there is a need for portal friendly user interface widgets that can detect environmental factors in a portal page and automatically adjust the markup they produce based on the detected environmental factors.

### SUMMARY OF THE INVENTION

In general, the present invention provides portal friendly user interface widgets that can detect environmental factors in a portal page and automatically adjust the markup they produce based on the detected environmental factors.

A first aspect of the present invention is directed to a portal friendly widget, comprising: a system for detecting at least one environmental factor in a portal page; and a system for automatically adjusting markup produced by the portal friendly widget based on the at least one detected environmental factor.

A second aspect of the present invention is directed to a method for adjusting markup in a portal page containing a portal friendly widget, comprising: detecting at least one environmental factor in the portal page; and automatically adjusting markup produced by the portal friendly widget based on the at least one detected environmental factor.

A third aspect of the present invention is directed to a program product stored on a recordable medium for adjusting markup in a portal page containing a portal friendly widget, which when executed, comprises: program code for detecting at least one environmental factor in the portal page; and program code for automatically adjusting markup produced by the portal friendly widget based on the at least one detected environmental factor.

A fourth aspect of the present invention is directed to a system for deploying an application for adjusting markup in a portal page containing a portal friendly widget, comprising: a computer infrastructure being operable to: detect at least one environmental factor in the portal page; and automatically adjust markup produced by the portal friendly widget based on the at least one detected environmental factor.

A fifth aspect of the present invention provides computer software embodied in a propagated signal for adjusting markup in a portal page containing a portal friendly widget, the computer software comprising instructions to cause a computer system to perform the following functions: detect at least one environmental factor in the portal page; and automatically adjust markup produced by the portal friendly widget based on the at least one detected environmental factor.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a “busy” portal page containing a plurality of portlets.

FIG. 2 depicts a portal page containing a single portlet or a portlet in its Maximized state.

FIG. 3 depicts a sequence of events for constructing a portal view.

FIG. 4 depicts a simple example of a portlet including a portal friendly table widget in accordance with the present invention.

FIG. 5 depicts the portlet of FIG. 4 after the markup produced by the portlet friendly table widget has been automatically adjusted based on detected environmental factors.

FIG. 6 depicts a more detailed example of a portlet including a plurality of portal friendly widgets in accordance with the present invention.

FIG. 7 depicts the portlet of FIG. 6 after the markup produced by the plurality of portal friendly widgets has been automatically adjusted based on detected environmental factors.

FIG. 8 depicts the portlet of FIG. 6 produced using a prior art method.

FIG. 9 depicts a computer system for providing a portal friendly widget in accordance with the present invention.

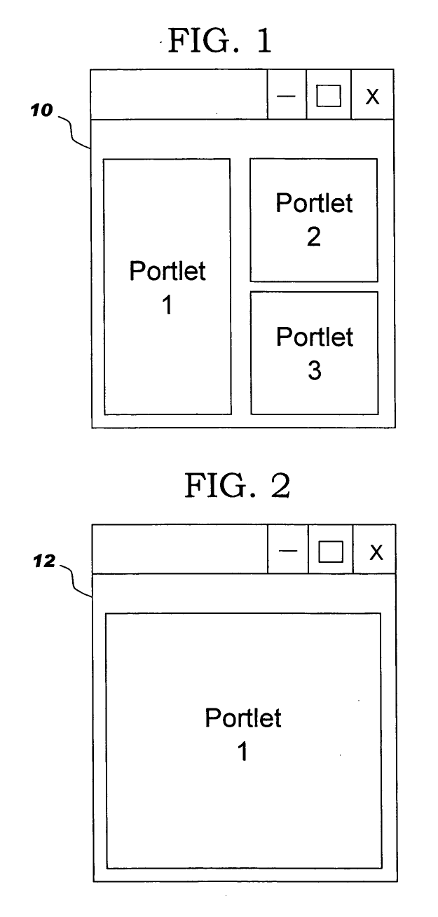

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

As indicated above, the present invention provides portal friendly user interface widgets that can detect environmental factors in a portal page and automatically adjust the markup they produce based on the detected environmental factors. It is assumed for the purposes of this description that the reader has an understanding of at least web portal technology (including portals, portlets, widgets, etc.) and Java.

A portal is an application that aggregates portlets together in a presentable format. Beyond merely being a presentation layer, a portal typically allows users to customize their presentation, including what portlets to display. A portal can also provide a convenient single sign-on mechanism for users.

A portlet is an individual web component that is made accessible to users via a portal interface. Typically, a single portlet generates only a fragment of the markup that a user sees from his or her browser. Users issue requests against portlets from the portal page. The portal in turn forwards those requests to a portlet container, which manages the lifecycle of a portlet.

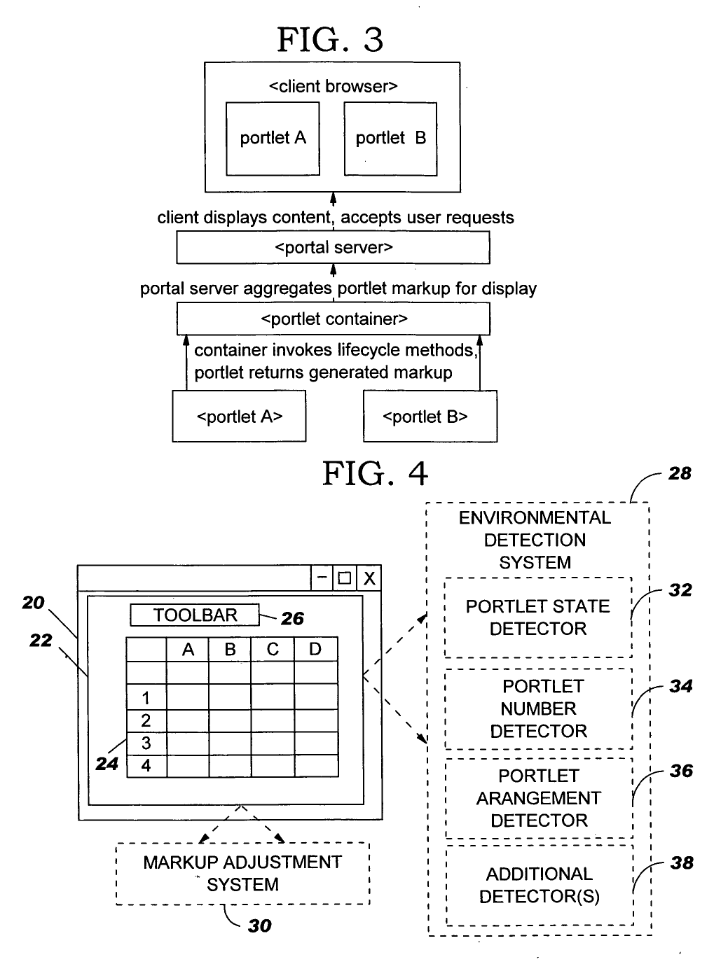

A portlet container sits between a portal and its portlets. A portlet container provides the run-time environment to portlets, much in the same way a servlet container provides the environment for servlets. The portlet container manages portlets by invoking their lifecycle methods. The portlet container forwards requests to the appropriate portlet. When a portlet generates a response, the portlet container sends the response to the portal to be rendered to the user. The sequence of events for constructing a portal view is illustrated in FIG. 3.

A widget is an element of a graphical user interface that displays information or provides a specific way for an user to interact with an application. Widgets include, for example, icons, pull-down menus, buttons, selection boxes, progress indicators, on-off check marks, scroll bars, windows, window edges (that let you resize the window), toggle buttons, forms, tables, and many other devices for displaying information and for inviting, accepting, and responding to user actions.

The present invention provides a new type of user interface widget called a “portal friendly widget.” Each portal friendly widget has the built-in capability to detect important environmental factors in a portal page and to automatically adjust the markup it produces based on the detected environmental factors. Examples of environmental factors that a portal friendly widget can detect include the state of the portlet that contains the portal friendly widget (e.g., minimized, maximized, normal, print, etc.) in a portal page, the number of portlets on a portal page, and the arrangement of portlets on a portal page. Other environmental factors are also possible.

A portal friendly widget can detect the state of a portlet by querying the PortletRequest object that is passed to the portlet in its doView method. Other techniques for detecting the state of the portlet containing the portlet friendly widget are also possible. The number and arrangement of portlets on a portal page are typically set up by a portal administrator. The portal administrator will have a set of portlets installed on a portal server from which he or she can choose. The portal administrator will then create a portal page and arrange the portlets as desired. This information can be provided to the portal friendly widget by the portal administrator or by the developer of the portal friendly widget. Other techniques for obtaining this information are also possible. End users can also add portlets to their portal pages and move the portlets after an administrator has installed them.

Based on the detected environmental factors, a portal friendly widget can automatically adjust the markup it produces in many different ways. For example, a portal friendly widget can adjust font size and/or typeface, add or remove decorative images, adjust the color palette used by the widget, enable or disable certain widget features (such as filtering controls in a portal friendly table widget), add or remove certain widget features, truncate certain parts of the data being presented (such as clipping the text in all nodes of a portal friendly tree widget at a certain number of characters), add or remove certain data; and provide an alternate method to view certain parts of the data being presented (such as making the contents of a wide table cell available via mouse fly-over in a tooltip instead of in-line). Many other markup adjustments are also possible. The markup adjustments can be provided, for example, to emphasize important data in the portlet friendly widget and to remove unimportant data in response to a reduction in size of a portlet.

The specific adjustments to the markup produced by a portal friendly widget in response to detected environmental factors are set up in advance by the developer of the portal friendly widget. For example, the developer of a portal friendly widget may designate that the font used by a portal friendly widget should be reduced from 12 point to 9 point whenever the portlet containing the portal friendly widget undergoes a state change from Maximized to Normal (and vice versa) in a portal page, that some/all of the images displayed by the portal friendly widget are removed whenever the portlet containing the portal friendly widget is included in a two column portal page, that certain features of the portal friendly widget are disabled wherever the portlet containing the portal friendly widget is included with three or more other portlets in a portal page, etc. As will be apparent to one skilled in the art, a wide variety of different/additional adjustments can be made to the markup produced by a portal friendly widget in response to detected environmental factors.

A portlet 20 including a simple example of a portal friendly “table” widget 22 in accordance with the present invention is depicted in FIG. 4. In this example, the table widget 22 is a complex widget made up of its own content (e.g., table 24) plus other widgets (e.g., toolbar 26, buttons, action menu, etc.). The portal friendly table widget 22 also includes a built-in environmental detection system 28 (shown in phantom) for detecting predetermined environmental factors, and a markup adjustment system 30 for adjusting the markup produced by the portal friendly table widget 22 based on the detected environmental factors. The built-in environmental detection system 28 can include, for example, a portlet state detector 32 for detecting the state of the portlet 20 that contains the portal friendly widget 22 (e.g., minimized, maximized, normal, print, etc.) in a portal page, a portlet number detector 34 for detecting the number of portlets on a portal page, and a portlet arrangement detector 36 for detecting the arrangement of portlets on a portal page. Additional detectors 38 for detecting other environmental factors can also be provided.

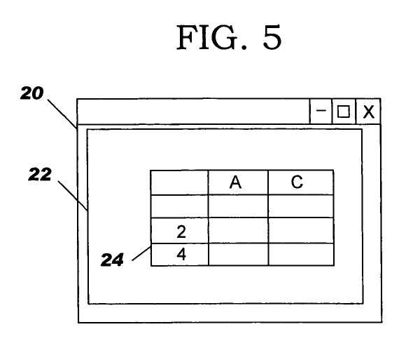

In FIG. 4, the portlet 20 that includes the portal friendly table widget 22 is depicted in its Maximized state within a portal page, with the entire portal friendly table widget 22 being displayed. As shown, all four rows (i.e., rows 1-4) and all four columns (i.e., columns A-D) of table 24 are displayed along with the toolbar 26 in the portlet 20. In FIG. 5, the portlet 20 is depicted in its Normal state within a portal page. In response to the detection by the portlet state detector 32 of this change of state (i.e., Maximized→Normal) in a portal page, the markup adjustment system 30 adjusts the markup produced by the portal friendly table widget 22 such that only the most important data is displayed. In this example, the developer of the portal friendly table widget 22 has coded the markup adjustment system 30 (FIG. 4) to only display rows 2 and 4 and columns A and C of the table 24, and not to display the toolbar 26, when the portlet 20 containing the portal friendly table widget 22 is displayed in the Normal state in a portal page.

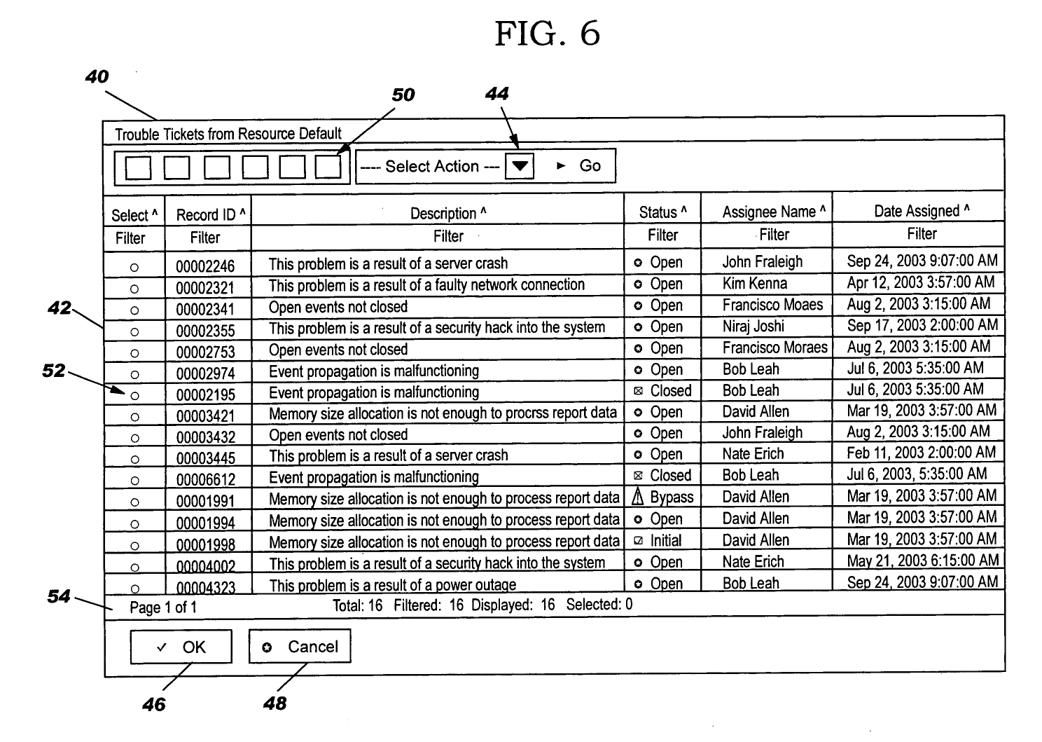

A portlet 40 including another example of a portal friendly table widget 42 is depicted in FIG. 6. Also shown in the portlet 40 are a portal friendly Select Action widget 44, a portal friendly OK button widget 46 and a portal friendly Cancel button widget 48. The portal friendly table widget 42 is fairly complex, and includes a toolbar widget 50, a table 52 comprising a plurality of sortable/filterable rows and columns, and a status indicator widget 54. In FIG. 6, it is assumed that the portlet 40 is displayed in its Maximized state in a portal page.

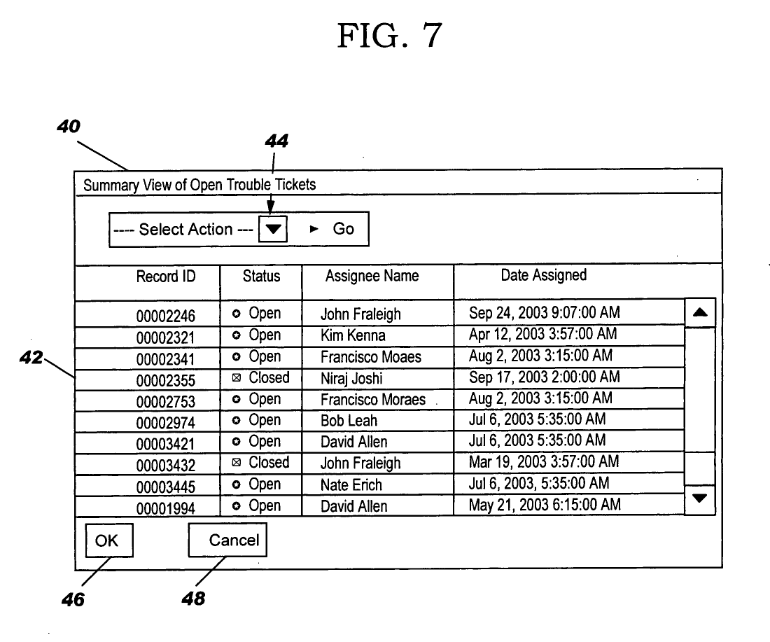

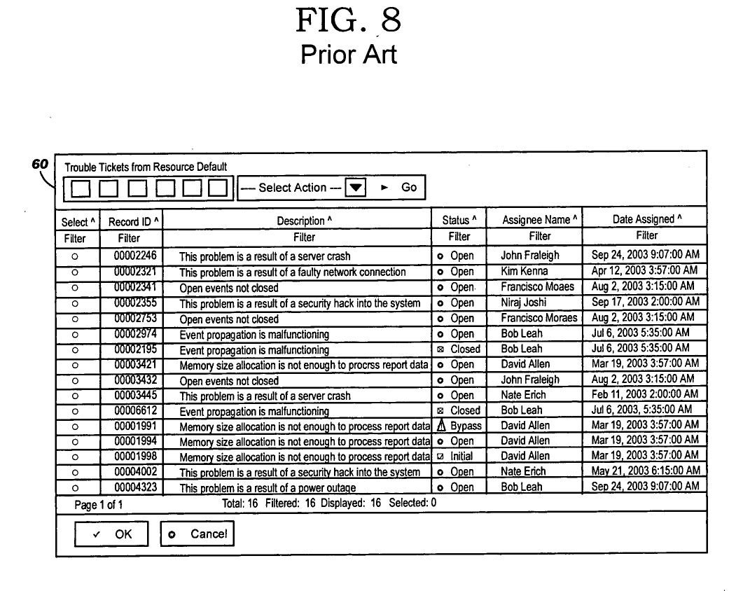

The portlet 40 is displayed in its Normal state in a portal page in FIG. 7. As shown, the markup produced by each of the portlet friendly widgets 42, 44, 46, and 48 has changed in response to the change of state of the portlet 40 from Maximized to Normal in a portal page. For example, the toolbar 50 and status indicator 54 of the portal friendly table widget 42 have disappeared. In addition, the images displayed within the GO button of the portal friendly Select Action widget 44, the portal friendly OK button widget 46 and the portal friendly Cancel button widget 48 have also disappeared. In the portlet friendly table widget 42, the Select and Description columns have disappeared, while the font used to display the text within the table 52 has increased in size. A scroll bar 49 for the rows has also been added. Less screen real estate is taken up by the portal friendly widgets and as much relevant data as possible is shown in the given space. This is how the portal friendly widgets would render if the portlet 40 containing them had to share a portal page with several other portlets, or perhaps if the portlet 40 was in a multicolumn layout in a portal page. Regardless, it should be noted that the portal developer has not made any code changes to cause this change in appearance. Comparing FIG. 7 with FIG. 8, which displays a corresponding portlet 60 in its Normal state produced in accordance with the prior art (i.e., without the use of the portal friendly widgets of the present invention), it is readily apparent that the portlet 40 produced using the portal friendly widgets of the present invention is much less cluttered and much more readable than a corresponding portlet of the same size produced in accordance with the prior art.

The portal friendly widgets of the present invention provide many advantages over the prior art. For example, portlet friendly widgets save development time because a portal developer does not have to write extra code to check for environmental factors and manually adjust widget properties. Portlet code written by a developer is also more portable across portal containers that provide portal friendly widgets already tuned to their specific environment. Since portal friendly widgets make efficient use of screen real estate, the end user can see more information on a page without scrolling. Portal friendly widgets can also help a crowded portal page look much less busy by limiting the amount of flashiness they provide or function they expose. Further, since the environmental factors detected by portal friendly widgets only affect the rendering of the widget and not the data it contains, the portlet code does not need to perform the expensive operations of changing the underlying data model. Also, once the environmental factors have been determined by the portal friendly widgets in one portlet they can be shared with all other portlets in the page. Another advantage is that more device and display types can be supported without application code changes.

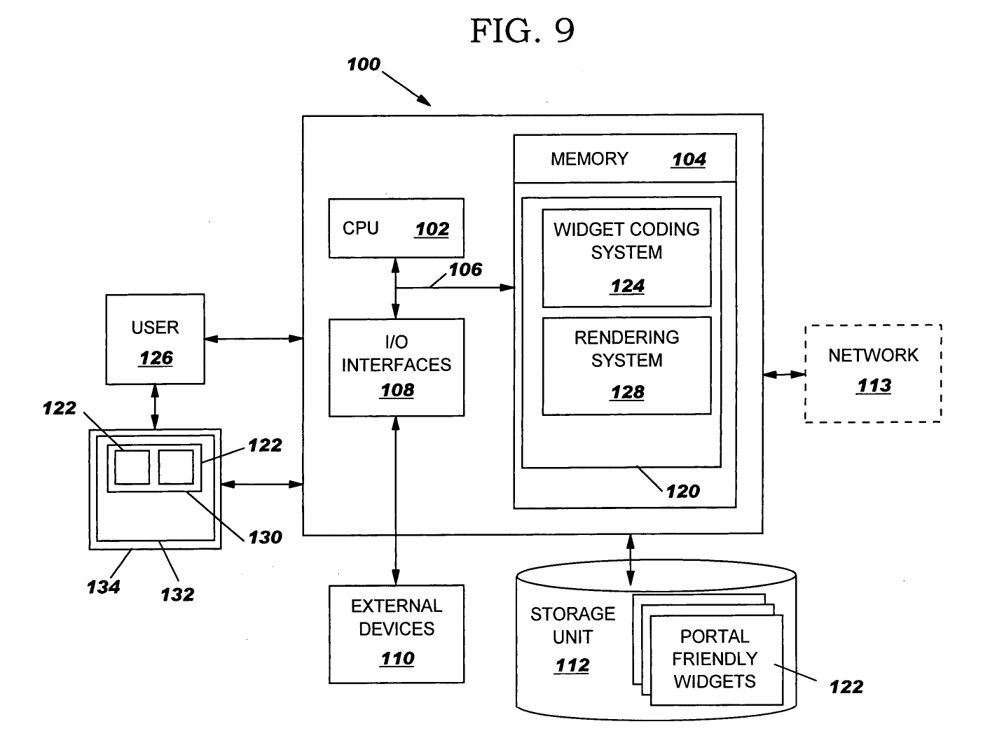

Referring now to FIG. 9, a computer system 100 capable of implementing and providing the portal friendly user interface widgets of the present invention is illustrated in detail. As shown, the computer system 100 generally comprises a central processing unit (CPU) 102, memory 104, bus 106, input/output (I/O) interfaces 108, external devices/resources 110, and storage unit 112. CPU 102 may comprise a single processing unit, or may be distributed across one or more processing units in one or more locations. Memory 104 may comprise any known type of data storage and/or transmission media, including magnetic media, optical media, random access memory (RAM), read-only memory (ROM), a data cache, a data object, etc. Moreover, similar to CPU 102, memory 104 may reside at a single physical location, comprising one or more types of data storage, or may be distributed across a plurality of physical systems in various forms.

I/O interfaces 108 may comprise any system for exchanging information to/from an external source. External devices/resources 110 may comprise any known type of external device, including speakers, a CRT, LCD screen, handheld device, keyboard, mouse, voice recognition system, speech output system, printer, monitor/display, facsimile, pager, etc. Bus 106 provides a communication link between each of the components in computer system 100 and likewise may comprise any known type of transmission link, including electrical, optical, wireless, etc.

Storage unit 112 can be any system capable of providing storage for information necessary for the practice of the present invention. As such, storage unit 112 may reside at a single physical location, comprising one or more types of data storage, or may be distributed across a plurality of physical systems in various forms. In another embodiment, storage unit 112 may be distributed across, for example, a local area network (LAN), wide area network (WAN) or a storage area network (SAN), shown generically in FIG. 9 as network 113.

Shown in memory 104 of computer system 100 is a portal friendly widget system 120, which may be provided as computer program product. The portal friendly widget system 120 is used to produce and render portal friendly widgets 122, which can be stored, for example, in storage unit 112. The portal friendly widget system 120 includes a portal friendly widget coding system 124 for producing portal friendly widgets 122. Each portal friendly widget 122 includes an environmental detection system 28 (FIG. 4), and a markup adjustment system 30 (FIG. 4) as described above. A portal friendly widget 122 can be produced by a user/developer 126. A rendering system 128 (e.g., a web browser) can be used to render portlets 130, containing one or more portlet friendly widgets 122, within a portal page 132 on display 134.

It should be appreciated that the teachings of the present invention could be offered as a business method on a subscription or fee basis. For example, computer system 100 could be created, maintained, supported, and/or deployed by a service provider that offers the functions described herein for customers. That is, a service provider could provide portal friendly user interface widgets that can detect environmental factors in a portal page and automatically adjust the markup they produce based on the detected environmental factors as describe above. A service provider could also provide a user/developer with the necessary tools for creating portal friendly widgets. It should also be understood that the present invention can be realized in hardware, software, a propagated signal, or any combination thereof. Any kind of computer/server system(s)—or other apparatus adapted for carrying out the methods described herein—is suited. A typical combination of hardware and software could be a general purpose computer system with a computer program that, when loaded and executed, carries out the respective methods described herein. Alternatively, a specific use computer, containing specialized hardware for carrying out one or more of the functional tasks of the invention, could be utilized. The present invention can also be embedded in a computer program product or a propagated signal, which comprises all the respective features enabling the implementation of the methods described herein, and which—when loaded in a computer system—is able to carry out these methods. Computer program, propagated signal, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

We claim:

1. A portal friendly widget, comprising:
a system for detecting at least one environmental factor in a portal page; and
a system for automatically adjusting markup produced by the portal friendly widget based on the at least one detected environmental factor.

2. The portal friendly widget of claim 1, wherein the system for detecting at least one environmental factor in a portal page further comprises:
a portlet state detector for detecting a state of a portlet that contains the portal friendly widget.

3. The portlet friendly widget of claim 2, wherein the portlet state is selected from the group consisting of Minimized, Maximized, Normal, Help, Configure and Print.

4. The portal friendly widget of claim 1, wherein the system for detecting at least one environmental factor in a portal page further comprises:
a portlet number detector for detecting a number of portlets in the portal page.

5. The portal friendly widget of claim 1, wherein the system for detecting at least one environmental factor in a portal page further comprises:
a portlet arrangement detector for detecting an arrangement of portlets in the portal page.

6. The portal friendly widget of claim 1, wherein system for automatically adjusting markup produced by the portal friendly widget is configured to perform at least one of the following:
adjust a font size;
adjust a font typeface;
adjust a color palette;
add or remove images;
enable or disable widget features;
add or remove widget features;
truncate data;
add or remove data; and
change view of data.

7. A method for adjusting markup in a portal page containing a portal friendly widget, comprising:
detecting at least one environmental factor in the portal page; and
automatically adjusting markup produced by the portal friendly widget based on the at least one detected environmental factor.

8. The method of claim 7, wherein the step of detecting at least one environmental factor in a portal page further comprises:
detecting a state of a portlet that contains the portal friendly widget.

9. The method of claim 8, wherein the portlet state is selected from the group consisting of Minimized, Maximized, Normal, Help, Configure and Print.

10. The method of claim 7, wherein detecting at least one environmental factor in a portal page further comprises:
detecting a number of portlets in the portal page.

11. The method of claim 7, wherein detecting at least one environmental factor in a portal page further comprises:
detecting an arrangement of portlets in the portal page.

12. The method of claim 7, wherein automatically adjusting markup produced by the portal friendly widget comprises at least one of the following:
adjusting a font size;
adjusting a font typeface;
adjusting a color palette;
adding or removing images;
enabling or disabling widget features;
adding or removing widget features;
truncating data;
adding or removing data; and
changing view of data.

13. A program product stored on a recordable medium for adjusting markup in a portal page containing a portal friendly widget, which when executed, comprises:
program code for detecting at least one environmental factor in the portal page; and
program code for automatically adjusting markup produced by the portal friendly widget based on the at least one detected environmental factor.

14. The program product of claim 13, wherein the program code for detecting at least one environmental factor in a portal page further comprises:
program code for detecting a state of a portlet that contains the portal friendly widget.

15. The program product of claim 14, wherein the portlet state is selected from the group consisting of Minimized, Maximized, Normal, Help, Configure and Print.

16. The program product of claim 13, wherein the program code for detecting at least one environmental factor in a portal page further comprises:
program code for detecting a number of portlets in the portal page.

17. The program product of claim 13, wherein the program code for detecting at least one environmental factor in a portal page further comprises:
program code for detecting an arrangement of portlets in the portal page.

18. The program product of claim 13, wherein the program product for automatically adjusting markup produced by the portal friendly widget is configured to perform at least one of the following:
adjust a font size;
adjust a font typeface;
adjust a color palette;
add or remove images;
enable or disable widget features;
add or remove widget features;
truncate data;
add or remove data; and
change view of data.

19. A system for deploying an application for adjusting markup in a portal page containing a portal friendly widget, comprising:
a computer infrastructure being operable to:
detect at least one environmental factor in the portal page; and
automatically adjust markup produced by the portal friendly widget based on the at least one detected environmental factor.

20. Computer software embodied in a propagated signal for adjusting markup in a portal page containing a portal friendly widget, the computer software comprising instructions to cause a computer system to perform the following functions:
detect at least one environmental factor in the portal page; and
automatically adjust markup produced by the portal friendly widget based on the at least one detected environmental factor.
